(19) United States
(12) Patent Application Publication
(10) Pub. No.: US 2025/0037191 A1
(43) Pub. Date: Jan. 30, 2025

(54) DERIVING TARGET PRICE INDICATORS TO OVERLAY ON A GRAPHICAL USER INTERFACE OF HISTORICAL PRICE VALUES WITH AVAILABLE CLICK-BASED AUTOMATED TRADING

(71) Applicant: Updata Limited, London (GB)

(72) Inventor: David Linton, London (GB)

(73) Assignee: Updata Limited, London (GB)

(21) Appl. No.: 18/785,579

(22) Filed: Jul. 26, 2024

Related U.S. Application Data
(60) Provisional application No. 63/516,295, filed on Jul. 28, 2023.

(51) Int. Cl. G06Q 30/0601; G06Q 40/04

(52) U.S. Cl. CPC G06Q 30/0641; G06Q 40/04

(57) ABSTRACT

The Linton Price Target invention produces a predictive future target price line on any graph of prices generated from an initial move in price off a low point or a high point in price. This gives traders and investors a visual roadmap of where the price could be at a future given date and the ability to monitor the path of prices along the Linton Price Target line. The Linton Price Target is also available with click-based automated trading.

### CROSS-REFERENCE TO RELATED APPLICATIONS

This application claims priority from and is related to U.S. Provisional Application No. 63/516,295, entitled “Target Price Indicator On A Graph Of Historical Price Values,” filed Jul. 28, 2023, which is hereby incorporated into the present application by reference in its entirety.

### TECHNICAL FIELD

The present disclosure generally relates to graphing future price market values for stocks, bonds, commodities, currencies, futures, or any other instrument that is traded or is bought and/or sold over a given period of time. More specifically, the present invention is a system for creating a target price indicator on a graph on a graphical user interface (GUI) on a graph of historical price values.

### BACKGROUND

There are many ways to analyze graphs of financial prices, but none of these can automatically project price targets in an objective rules-based manner, i.e., with a key press or mouse click.

In 1948 a technique was invented by A. W. Cohen for projecting vertical count targets on point and figure charts. These charts of columns of Xs (upward price movement) and Os (downward price movement) were developed over the preceding decades as a shorthand for recording price movement. The charts were largely superseded with the birth of computer and telecommunications technology, where every price could be easily captured and stored. This allowed for line, bar, or candlestick charts to be drawn containing every price plotted on a time axis.

### SUMMARY OF THE INVENTION

Disclosed is a novel system and method for creating a target price indicator on a graph of historical price values, such as market prices for stocks, bonds, commodities, currencies, futures, and any other instrument that is traded over a given period of time. There are two cases: i) an upside target and ii) a downside target.

For the upside target, the process begins by accessing a set of historical price values, each of which is associated with a time period. In one example, the time period is one of minutes, hours, days, weeks, months, years, or a combination thereof.

Next, an upside target is determined by calculating from the historical price values: i) a price low level (L) based on at least one price unit (U) below a previous recent low price point; and ii) an initial thrust (t) based on a number of price units that a price moves higher from the price low level (L), without reversing (r) by at least a user-configurable number of price units.

In response to a price of the historical price values being reversed (r) by the user-configurable number of at least one price unit (U): i) setting an initial thrust (t) and a resultant price move to a target price; and ii) calculating a target price level (T) by a configurable target price factor (F) multiplied by the initial thrust (t). In one example, the reversal (r) by at least a user-configurable number of price units is one of an arithmetic price unit (U) or a percentage price unit (U) of the price.

In response to the price of the historical price values increasing to a level that is at least one price unit (U) greater than a local maximum price value of the initial thrust (t) for a resultant price target to be activated, automatically calculating a target price indicator, with i) an initial point of the target price indicator starting at a point of activation price unit; and ii) a slope of the target price indicator is based on the target price level (T) and a time to target (x). The target price indicator is one of a line, an arrow, a shape, a geometric shape, or a combination thereof. In one example, the target price level (T) is equal to T=L+t+(F×t), where the L is the price low level, t is the initial thrust, and F is the configurable target price factor. The initial value for F maybe one of 1, 1.618, 2, and 2 at log scale. The price unit (U) may be an arithmetic value or percentage value of the price (P).

Presenting, via a graphical user interface (GUI), the calculated target price indicator with the set of historical values on a first axis versus the time period on a second axis.

In another example, that presenting via the GUI, includes an activation region, which is a geometric shape with a first dimension based on the price unit (U) and a second dimension based on a time to activation (a).

For the downside target, the process begins by accessing a set of historical price values, each of the historical price values associated with a time period.

Next a downside target is determined by calculating from the historical price values: i) a price high level (H) based on at least one price unit (U) above a previous recent high price point; and ii) an initial thrust (t) based on a number of price units that a price moves lower from the price high level (H), without reversing (r) by at least a user-configurable number of price units.

In response to a price of the historical price values being reversed by (r) then i) setting an initial thrust (t) and a resultant price move to a target price; and ii) calculating a target price level (T) by a configurable target price factor (F) multiplied by the initial thrust (t).

In response to price of the historical price values decreasing to a level that is at least one price unit (U) less than a local minimum price value of the initial thrust (t) for a resultant price target to be activated, automatically calculating a target price indicator, with i) an initial point of the target price indicator starting at a point of activation price unit; and ii) a slope of the target price indicator is based on the target price level (T) and a time to target (x).

Presenting, via a graphical user interface (GUI), the calculated target price indicator with the set of historical values on a first axis versus the time period on a second axis.

In one example, the slope of the target price indicator is based on the configurable target price factor (F) multiplied by the initial thrust (t) divided by the time to target (x), and wherein the time to target (x) is from the point of activation which occurs when at least one price unit (U) is reached above a high point of the initial thrust (t), and wherein a value of the time to target (x) is settable by a user.

In another example, the slope of the target price indicator is based on the time to target (x) at a same angle as a slope angle of the initial thrust (t), and wherein the time to target (x) is from the point of activation which occurs when at least one price unit (U) is reached above a high point of the initial thrust (t), and wherein a value of the slope is settable by a user.

In another example, the slope of the target price indicator is based on the time to target (x) is a multiple of a user-configurable factor of time to activation (a), and wherein the time to target (x) is from the point of activation which occurs when at least one price unit (U) is reached above a high point of the initial thrust (t), and wherein a value of the time to target (x) is settable by a user.

In another example, the slope of the target price indicator is based on following prices as they occur as time progresses after that target price indicator is activated, such that the slope of the target price indicator adjusts according to prices as they occur.

In another example, the slope of the target price indicator is based on an arithmetic combination of previous slopes of previous target price indicators, a number of previous target price indicators are is settable by a user.

In still another example, the slope of the target price indicator is based on following a price of the historical price values as it progresses to the target price.

### BRIEF DESCRIPTION OF THE DRAWINGS

A more complete understanding of the present disclosure and the attendant advantages and features thereof, will be more readily understood by reference to the following description when considered in conjunction with the accompanying drawings wherein:

FIG. 1 is an example prior art point and figure chart of a commodity, such as crude oil, illustrating point and figure targets.

FIG. 2 is an example graph of Linton Price Targets of the same commodity of that as shown in FIG. 1 on a line graph of the price of crude oil with the Linton Price Targets projecting forward in time, according to one aspect of the present invention;

FIG. 3A is an example diagram illustrating the theory behind the original point and figure chart for an upside case with vertical count targets of FIG. 1, according to the prior art;

FIG. 3B is an example line diagram that illustrates how FIG. 3A would look on a simplified line chart illustrating an upside count where every price is recorded such that there is a time axis, according to one aspect of the present invention;

FIG. 4A is an example diagram illustrating the theory behind the original point and figure chart for a downside case with vertical count targets of FIG. 1, according to the prior art;

FIG. 4B is an example diagram that illustrates how FIG. 4A would look on a simplified line chart illustrating a downside count where every price is recorded such that there is a time axis, according to one aspect of the present invention;

FIG. 5 is an example diagram with the variables behind the Linton Thrust Target calculation for an upside target, according to one aspect of the present invention.

FIG. 6 is an example diagram with the variables behind the Linton Thrust Targets for a downside target, according to one aspect of the present invention;

FIG. 7 is an example graph illustrating a daily candle chart of the Nasdaq 100 Index with Linton Price Targets using a price/time factor method, according to one aspect of the present invention;

FIG. 8 is an example graph illustrating a daily candle chart of a weekly cloud chart of Gold using Linton Price Targets with a thrust angle method, according to one aspect of the present invention;

FIG. 9 is an example graph illustrating a one-minute line graph of the British Pound to US Dollar using Linton Price Targets with a time to activation method, according to one aspect of the present invention;

FIG. 10 is an example graph illustrating an hourly bar chart of the stock price of Apple Inc. using Linton Price Targets with a follow the price method, according to one aspect of the present invention;

FIG. 11 is an example graph illustrating an daily bar chart of the stock price of Apple Inc. with target projections using an average of the previously met targets to project a time to target, according to one aspect of the present invention;

FIG. 12 is an example graph with a state of a Linton Thrust Target once generated with classifications for an upside target, according to one aspect of the present invention;

FIG. 13 is an operational flow diagram of FIG. 12 that illustrates an upside target calculation for creating a target price indicator on a graph of historical price values, according to one aspect of the present invention;

FIG. 14 is an example graph with the variables behind the Linton Thrust Targets classifications for a downside target, according to one aspect of the present invention;

FIG. 15 is an operational flow diagram of FIG. 14 that illustrates a downside target calculation for creating a target price indicator on a graph of historical price values according to one aspect of the present invention;

FIG. 16 is an operational flow diagram that illustrates an alert based on pre-trade analytics of FIG. 2 through FIG. 15 above for sending a trade order to an electronic exchange, according to one aspect of the present invention;

FIG. 17 is a user interface with the variables behind the Linton Thrust Target calculation for an upside target of FIG. 5 illustrating a region with data used for sending a trade order to an electronic exchange, according to one aspect of the present invention;

FIG. 18 is a user interface with the variables behind the Linton Thrust Target calculation for a downside target of FIG. 6 illustrating a region with data used for sending a trade order to an electronic exchange, according to one aspect of the present invention;

FIG. 19 is an example of variables used for sending a trade order to an electronic exchange using data from FIG. 17 and FIG. 19 above, according to one aspect of the present invention; and

FIG. 20 is an example block diagram of the error auditing and dispute system that can be utilized in embodiments of the present disclosure.

### DETAILED DESCRIPTION OF THE DISCLOSURE

As required, embodiments are disclosed herein; however, it is to be understood that the disclosed embodiments are merely examples and that the methods described below can be embodied in various forms. Therefore, specific structure and functional details disclosed herein are not to be interpreted as limiting, but merely as a representative basis for teaching one skilled in the art to variously employ the present subject matter in virtually any appropriately detailed structure and function. Further, the terms and phrases used herein are not intended to be limiting, but rather, to provide an understandable description of the concepts.

### Non-Limiting Definitions

The terms “a”, “an” and “the” are intended to include the plural forms as well unless the context clearly indicates otherwise.

The term “about” or “approximately” applies to all numeric values, whether or not explicitly indicated. These terms generally refer to a range of numbers that one of skill in the art would consider equivalent to the recited values (i.e., having the same function or result). In many instances, these terms may include numbers that are rounded to the nearest significant figure.

The term “activation price unit” is a user-configurable price value after a Reversal occurs. This may or may not be user configurable.

The term “adapted to” describes the hardware, software, or a combination of hardware and software that is capable of, able to accommodate, to make, or that is suitable to carry out a given function.

The term “another”, as used herein, is defined as at least a second or more.

The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

The phrases “at least one of <A>, <B>, . . . and <N>” or “at least one of <A>, <B>, . . . . N, or combinations thereof” or “A, B, . . . and or N” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The term “communicate,” as well as derivatives thereof, encompasses both direct and indirect communication.

The terms “comprises” and/or “comprising”, when used in this specification, specify the presence of stated features, steps, operations, elements, and/or components but do not preclude the presence or addition of one or more other features, integers, steps, operations, elements, components, and/or groups thereof.

The term “configured to”, describes the hardware, software, or a combination of hardware and software that is adapted to, set up, arranged, built, composed, constructed, designed, or that has any combination of these characteristics to carry out a given function.

The term “coupled”, is defined as “connected,” although not necessarily directly and not necessarily mechanically.

The term “downside target” means setting a target price from a high point that is higher than a previous high point of prices.

The term “historical price values” means market prices for stocks, bonds, commodities, currencies, futures, and any other instrument that is traded over a given period of time.

The terms “including” and “having,” as used herein, are defined as comprising (i.e., open language).

The term “initial thrust (t)” is a user-configurable value for the number of whole discrete price units (U) that the price moves higher from a price low level (L) in the case of an upside target, or where the price moves lower from the price high level (H) in the case of a downside target, without reversing by r units or more. The initial thrust (t) can be an arithmetic price unit (U) or a percentage price unit (U) of price.

The term “initial thrust move off high price” is represented by a line with a negative slope in a price versus time graph when the condition for an initial thrust (t) is met.

The term “initial thrust move off low price” is represented by a line with a positive slope in a price versus time graph when the condition for an initial thrust (t) is met.

The term “Linton Price Target” is the commercial name of one embodiment of the claimed invention, created by inventor David Linton MFTA, a well-known technical analyst of financial markets, and is available from Updata Ltd with offices in London, United Kingdom, and online URL <https://www/updata.co.uk>.

The term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The term “point-and-figure (P &F) chart” means a plot of price movements for stocks, bonds, commodities, or futures without considering the passage of time. Contrary to other charts, like candlesticks, which mark the degree of an asset's movement over set time periods, P&F charts utilize columns consisting of stacked X's or O's, each representing a set amount of price movement. The X's illustrate rising prices, while O's represent falling prices.

The term “price line (P)” is a graphical representation of a historical price in a price versus time plot. Usually, time is on the X-axis, and the price is on the Y-axis, but may be switched. The units of measure for each of the X and Y axis are user-configurable.

The term “price low level (L)” is a user-configurable value for a low or local minimum point in terms of price. The Low is at least one price unit (U) below a previous recent low point. A recent duration is user-configurable and typically measured in hours, days, weeks, or months.

The term “price high level (H)” is a user-configurable value for a high or local maximum point in terms of price. Typically the High is at least one price unit (U) above a previous recent high point. As defined below, Recent, is user-configurable, such as a Recent duration, is user-configurable and typically measured in hours, days, weeks, or months.

The term “price unit (U)” is a user-configurable value for a unit of measure of price. These are typically positive integer numbers. In US currency, typical price units maybe $1, $5, $10, and other values.

The term “recent” is a user-configurable duration of time that may be used with a price high level (H), a price low level (L), or both. Recent is typically measured in minutes, hours, days, weeks, months, or years.

The term “resultant price move to target” for downside target is represented by a line with a negative slope in a price versus time graph from an initial thrust (t) to the target price level (T).

The term “resultant price move to target” for upside target is represented by a line with a positive slope in a price versus time graph from an initial thrust (t) to the target price level (T).

The term “reversal (r)” means a user-configurable number of Price Units (U) a price reverses. This is typically set to 3 on point and figure charts but is user-configurable to greater or less.

The term “simultaneous” means computations are carried out at the same time, which for larger data sets with various constraints, is not possible to be carried out completed by a group of humans and must be performed by a computer. For example, one human could not calculate or compute Linton Price Target on real-time data.

The terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

The term “target price” is the price point produced from the Linton Price Target with variables and settings configurable by the end user within a given period of time. The presently claimed invention provides Linton Price Targets which are an interactive graphical method for presenting a predicted future price and at a future date by graphing price targets, set by a series of rules and variables, on graphs of prices that have a time axis.

The term “target price indicator” is a an element of a graphical user interface that displays information or provides a specific way for a user to interact with the operating system (OS) or an application. In one embodiment, the Target Price Indicator is a geometric shape, such as a line, arrow, or rectangle but other shapes are possible.

The term “target price factor (F)” is a user-configurable value based on buying and selling thrusts. The current version of the Linton Price Targets provides four target price factors (F) as follows:
Pattern—move out of a pattern equate to a move in (also triangles), subjectively required—1×
Fibonacci—retracements and extensions, subjectivity required—1.618×
Point and Figure (P&F)—3 box vertical counts—arithmetic-2×
Point and Figure (P&F)—3 box vertical counts-logarithmic-greater than 2×

Other target price factors (F) are possible as well.

The term “target price level (T)” is determined by a configurable Target Price Factor (F) multiplied by the Initial Thrust (t). This is equal to: Price Low Level (L)+Initial Thrust (t)+Target Price Factor (F)×Initial Thrust (t), i.e., T=L+t+(F×t). Popular factors for the user will be: 1, 2, 1.618, 1 & 2 log scale whereby Price Units are the same in percentage terms but vary arithmetically as the Price (P) varies, but any target Price Factor is user-configurable.

The term “thrust” is an initial move in price off a low point or a high point that ultimately generates the Target. Thrusts include buying thrust and selling thrust.

The term “time to activation (a)” is the amount of time between the end of an Initial Thrust and an Activation Price Unit being met.

The term “time to target (x)” is the amount of time, in units which may be determined by the user, between an Activation Price Unit being met and reaching the Target Price Level (T).

The term “upside target” means setting a target price from a low point that is lower than a previous low point of prices.

Note that not all of the activities described above in the general description or the examples are required, that a portion of a specific activity may not be required, and that one or more further activities can be performed in addition to those described. Still further, the order in which activities are listed is not necessarily the order in which they are performed.

### General Overview

The presently claimed invention greatly improves the point and figure (P&F) chart and their vertical count targets.

The three main problems with the traditional point and figure (P&F) chart are:
The charts are old-fashioned, and hardly anyone uses them anymore
There is no time axis on a point and figure chart, so there is no way of predicting at what point in time in the future, a price target might be met.
With no time axis on point and figure it is not possible to visually assess with the passage of time, if a price target is on track to be met.

More specifically, the presently claimed invention provides a new price target method that is not limited to the rules of the point and figure technique.

The presently claimed invention overcomes each of these limitations with the traditional point and figure charts. The presently claimed invention is being marketed as The Linton Price Target method, was created by inventor David Linton MFTA, a well-known technical analyst of financial markets, and is available from Updata Ltd with offices in London, United Kingdom, and online URL <https://www/updata.co.uk>.

### Charting Comparison

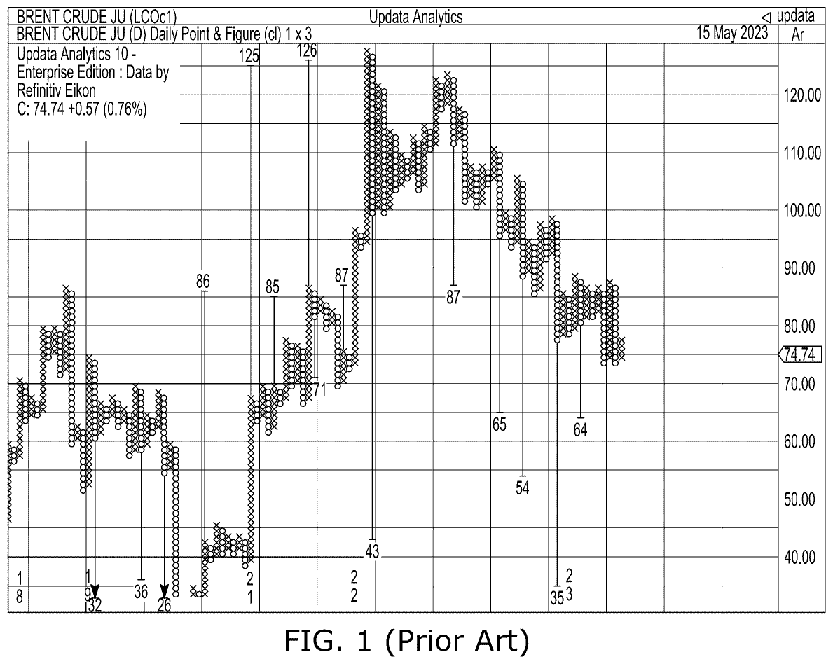

FIG. 1 is an example P&F chart of a commodity, such as crude oil, illustrating point and figure targets. The point and figure charting technique is used in technical analysis. P&F charting does not plot price against time as time-based charts do. Therefore, notice that this P&F chart does not include a time axis. P&F charts are based primarily on price action, not time. If there are no significant price moves over time, P&F charts will show no new data. This difference can make P&F charts ideal for detecting directional patterns and trends in a condensed format.

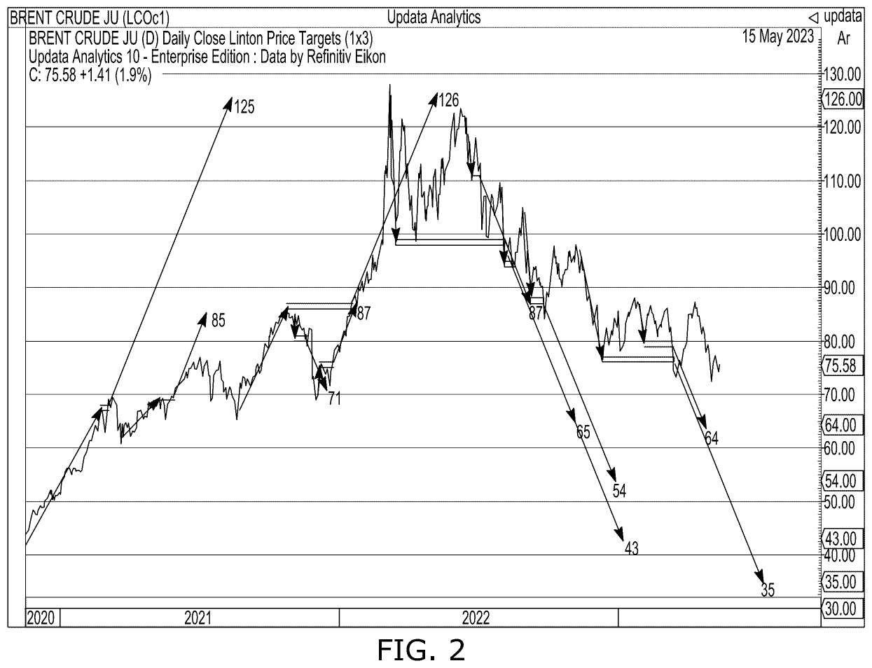

In comparison, FIG. 2 is an example graph of Linton Price Targets of the same commodity of that as shown in FIG. 1 on a line graph of the price of crude oil with the Linton Price Targets projecting forward in time.

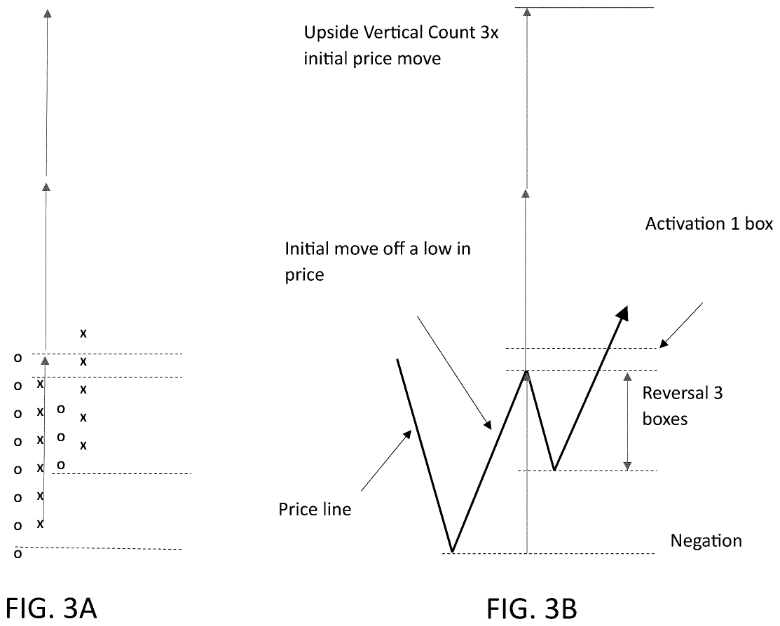

FIG. 3A is an example diagram illustrating the theory behind the original point and figure chart for an upside case with vertical count targets of FIG. 1. The correct way to draw a point and figure chart is to plot every price change, but practicality has rendered this difficult to do for a large quantity of stocks so many point and figure chartists use the summary prices at the end of each day. Some prefer to use the day's closing price, and some prefer to use the day's high or low, depending on the direction of the last column. The high/low method was invented by A. W. Cohen in his 1947 book, “How to Use the Three-Point Reversal Method of Point & Figure Stock Market Timing.” In one example, the claimed invention may use the close method. In another example, the claimed invention may use the high/low method

The P&F charts are constructed by deciding on the value represented by each X and O. Any price change below this value is ignored. So P&F charts act as a sieve to filter out the smaller price changes. The charts change column when the price changes direction by the value of a certain number of Xs or Os. Traditionally this was one and is called a “1 box reversal chart.” More common is three, called a “3 box reversal chart.”

FIG. 3B is an example line diagram that illustrates how FIG. 3A would look on a simplified line chart illustrating an upside count where every price is recorded such that there is a time axis.

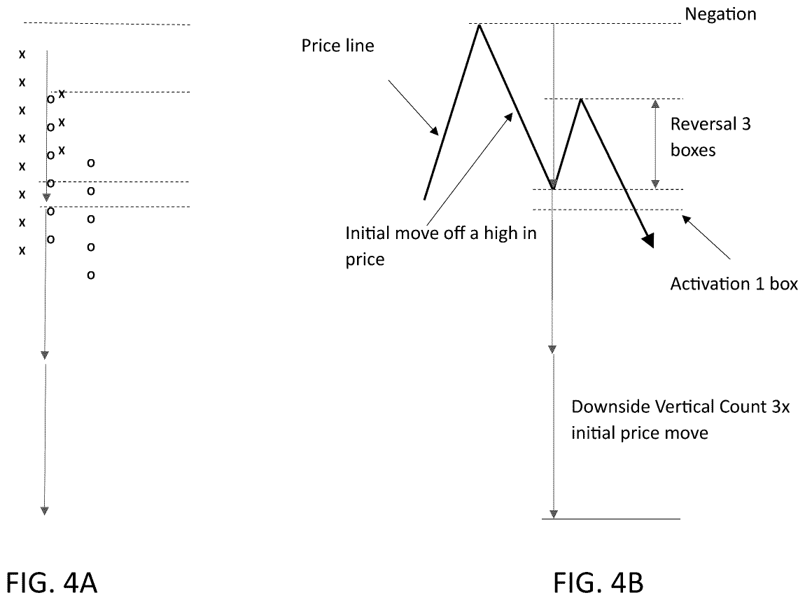

FIG. 4A is an example diagram illustrating the theory behind the original point and figure chart for a downside case with vertical count targets of FIG. 1.

FIG. 4B is an example diagram that illustrates how FIG. 4A would look on a simplified line chart illustrating a downside count where every price is recorded such that there is a time axis, according to one aspect of the present invention;

### Linton Thrust Targets for Upside Case

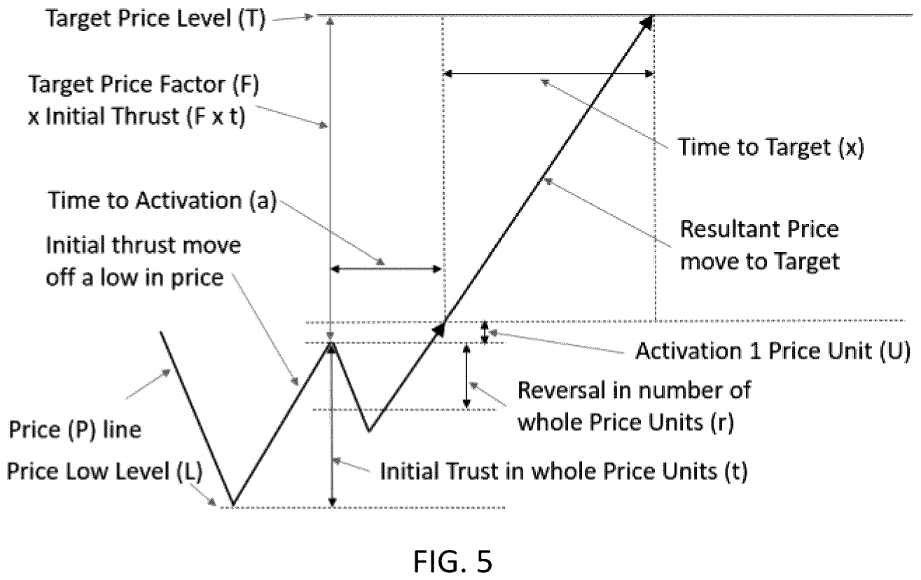

FIG. 5 is an example graph with the variables behind the Linton Thrust Target calculation for an upside target. Note the following variables are defined in the section entitled “Non-Limiting Definition” above, including each of:
Price High Level (H)
Price Line (P)
Initial Thrust Move off a High Price
Time to Activation (a)
Target Price Factor (F)
Target Price Level (T)
Initial Trust in Whole Price Units (t)
Reversal in number of whole Price Units (r)
Activation 1 Price Unit (U)
Resultant Price move to Target
Time to Target (x)

The definitions above correspond to FIG. 5 for the upside case. The rules for the Linton Price Targets (Upside) are as follows:
1. A Price Low Level (L) needs to be formed, whereby the Low is at least 1 Price Unit (U) below a previous recent low point
2. The initial thrust is the number of whole discrete Price Units (t) that the price moves higher from the Price Low Level without reversing by (r) units or more. This can be an arithmetic Price Unit (U) or a percentage Price Unit (U) of the price which software settings allow for.
3. Once the price of the instrument reverses by (r), normally set to 3 on point and figure charts but configurable to less or greater, the Initial Thrust (t) is set, and the Resultant Price move to Target is set as well.
4. The Target Price Level is determined by a configurable Target Price Factor (F) multiplied by the Initial Thrust (t). This is equal to: Price Low Level (L)+Initial Thrust (t)+Target Price Factor (F)×Initial Thrust (t), i.e., T=L+t+(F×t). Popular factors for the user will be: 1, 2, 1.618, 1 & 2 log scale whereby Price Units are the same in percentage terms but vary arithmetically as the Price (P) varies, but any target Price Factor can be set.
5. The price then needs to rise to a level that is at least 1 Price Unit (U) above the top level of the Initial Thrust (t) for the Resultant Price Target to be Activated, which increases the likelihood of the Target Price Level being met.

### Linton Thrust Targets for Downside Case

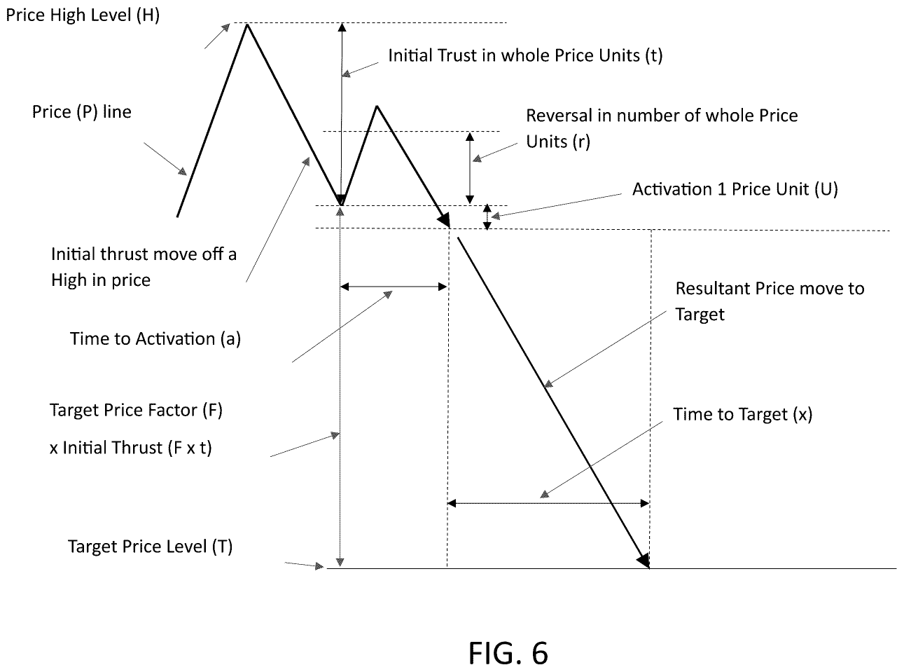

FIG. 6 is an example graph with the variables behind the Linton Thrust Targets for a downside target. Note the following variable are defined in the section entitled “Non-Limiting Definition” above, including each of:
Price Low Level (L)
Price Line (P)
Initial Thrust Move off a High Price
Time to Activation (a)
Target Price Factor (F)
Target Price Level (T)
Initial Trust in Whole Price Units (t)
Reversal in number of whole Price Units (r)
Activation 1 Price Unit (U)
Resultant Price move to Target
Time to Target (x)

The definitions above correspond to FIG. 6 for the downside case.

The rules for the Linton Price Targets (Downside) are as follows:
1. A Price High Level (H) needs to be formed, whereby the High is at least 1 Price Unit (U) above a previous recent high point.
2. The initial thrust is the number of whole discrete Price Units (t) that the price moves lower from the Price High Level (H), without reversing by (r) units or more.
3. Once the price of the instrument reverses by (r), or greater, the Initial Thrust (t) is set, and the Resultant Price move to Target is set as well.
4. The Target Price Level is determined by a configurable Target Price Factor (F) multiplied by the Initial Thrust (t). This is equal to: Price High Level (L)−Initial Thrust (t)−Target Price Factor (F)×Initial Thrust (t), i.e., T=H−t−(F×t).
5. The price then needs to fall to a level that is at least 1 Price Unit (U) below the bottom level of the Initial Thrust (t) for the Resultant Price Target to be Activated (A) Price Low Level (L) needs to be formed, whereby the Low is at least 1 Price Unit (U) below a previous recent low point.

### Time To Target Examples

An important aspect of the Linton Price Targets over the traditional P&F charts is they are applied to time-based graphs such as line, bar, or candlestick charts which allows them to be projected to a future date or time on short-term charts. Currently, there are five (5) time to target projection methods as follows: 1) Price/Time Factor; 2) Thrust Angle; 3) Time To Activation; 4) Follow the Price, and 5) Average of Previous Met Targets to Project a Time to Target. It is important to note that there are other target projection methods possible, and these are not exhaustive lists.

Each of these five (5) time to target projections are now discussed.

### Target Projections Using Price/Time Factor

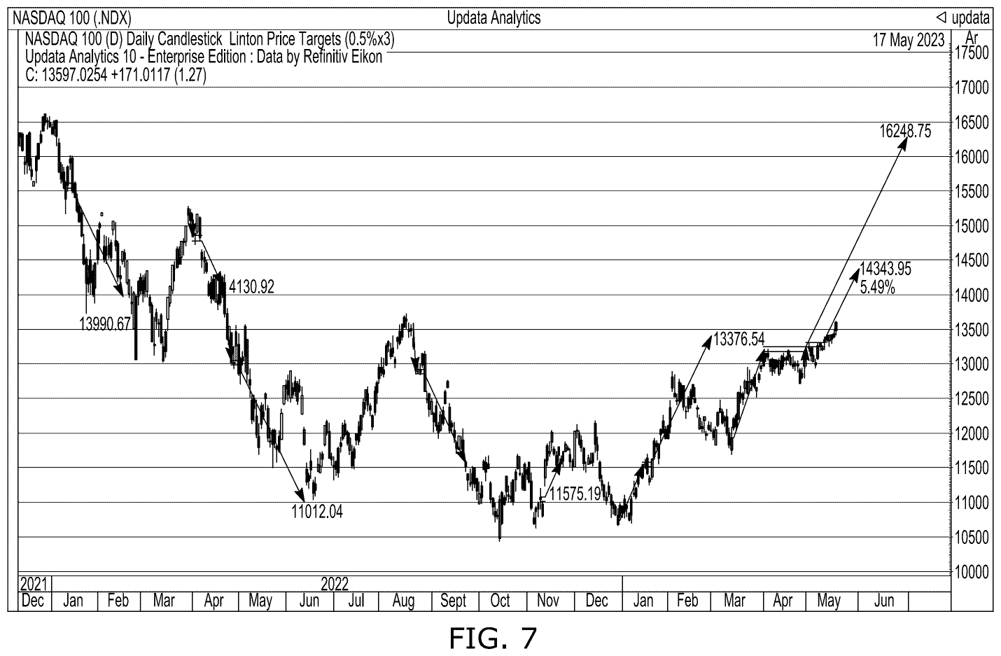

FIG. 7 is an example graph illustrating a daily candle chart of the Nasdaq 100 Index with Linton Price Targets using a price/time factor method. The setting for this graph is:
Target Unit (U) is 0.5% of Price (Log—i.e., 0.5% of price at any point on the chart)
Reversal in Units (r)=3
Target Price Thrust Factor (F)=2 (log scale)
Price/Time Factor=0.5%/1 (i.e., 0.5% per day)

Using this method (upside case), a Price Low Level (L) needs to be formed, whereby the Low is at least 1 Price Unit (U) below a previous recent low point, as shown.

### Target Projections Using Thrust Angle

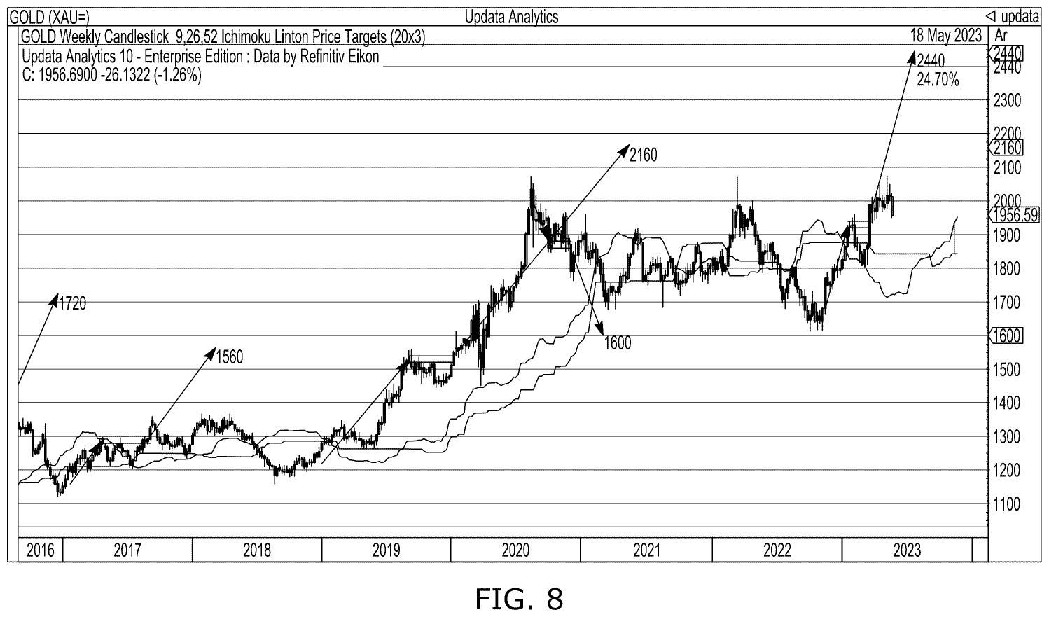

FIG. 8 is an example graph illustrating a daily candle chart of a weekly cloud chart of Gold using Linton Price Targets with a thrust angle method. The setting for this graph is:
Target Unit (U) is $20
Reversal in Units (r)=3
Target Price Thrust Factor (F)=2
Angle slope ratio=1

Using this method (upside case), the initial thrust is the number of whole discrete Price Units (t) that the price moves higher from the Price Low Level (L), without reversing by (r) units or more.

### Target Projections Using Time To Activation

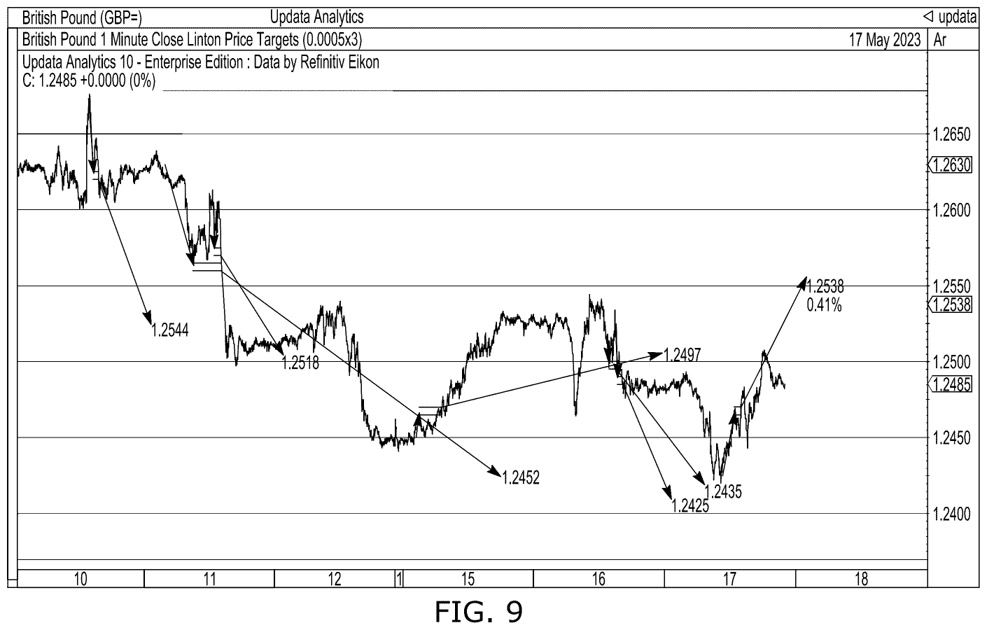

FIG. 9 is an example graph illustrating a one-minute line graph of the British Pound to US Dollar using Linton Price Targets with a time to activation method. The setting for this graph is:
Target Unit (U) is $0.0005 of Price (i.e. 0.05c)
Reversal in Units (r)=3
Target Price Thrust Factor (F)=1.618 (Fibonacci Golden Ratio number)
Time to Target/Time to Activation Ratio=10

Using this method, once the price of the instrument reverses by (r), or greater, the Initial Thrust (t) is set, and the Resultant Price move to Target is set as well. The time to target value is also a factor in the value of the time to activation.

### Target Projections Using Follow the Price

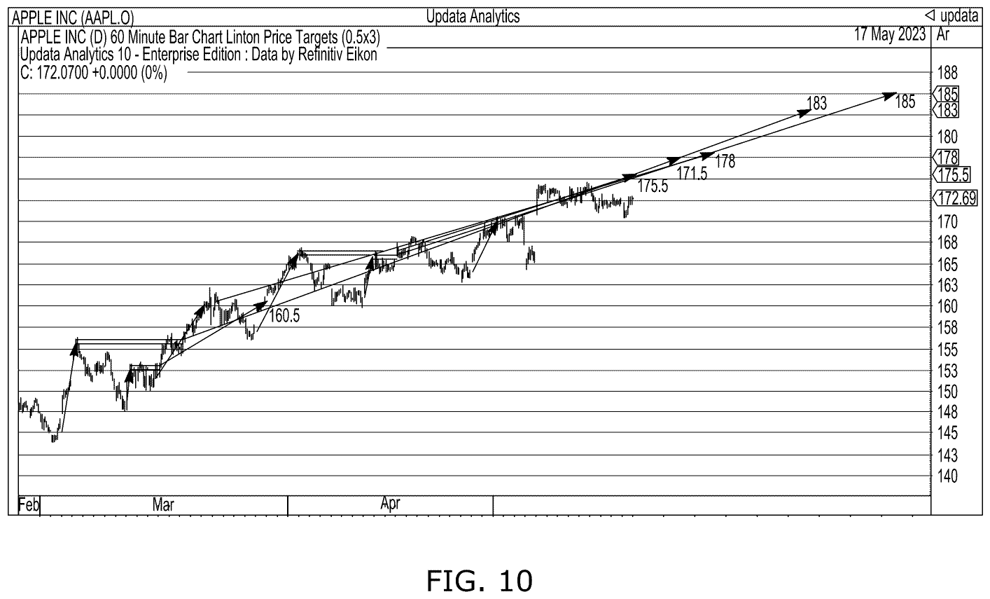

FIG. 10 is an example graph illustrating an hourly bar chart of the stock price of Apple Inc. using Linton Price Targets with a follow the price method. The setting for this graph is:
Target Unit (U) is $0.5 of Price (i.e. 50c)
Reversal in Units (r)=3
Target Price Thrust Factor (F)=2.
Follow the Price—here ignoring last 30 bars (an order to see any divergence from target track)

Using this method, the Target Price Level is determined by a configurable Target Price Factor (F) multiplied by the Initial Thrust (t). This is equal to: Price Low Level (L)+Initial Thrust (t)+Target Price Factor (F)×Initial Thrust (t), i.e., T=H+t+ (F×t).

### Target Projections Using Average of Previous Met Targets to Project a Time to Target

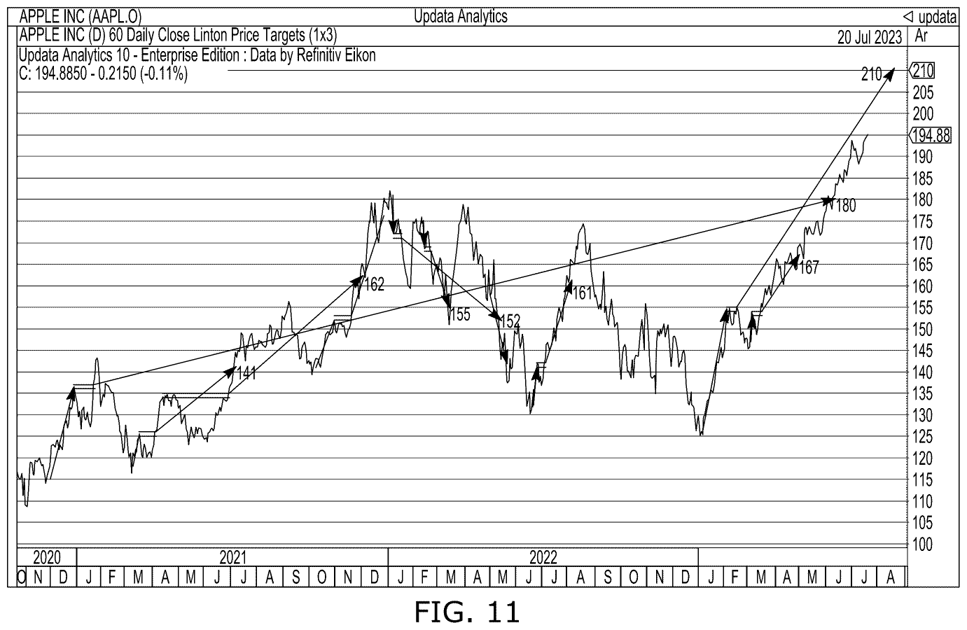

FIG. 11 is an example diagram illustrating a daily bar chart of the stock price of Apple Inc. with target projections using an average of the previously met targets to project a time to target, according to one aspect of the present invention.

### Target Status for Upside Case

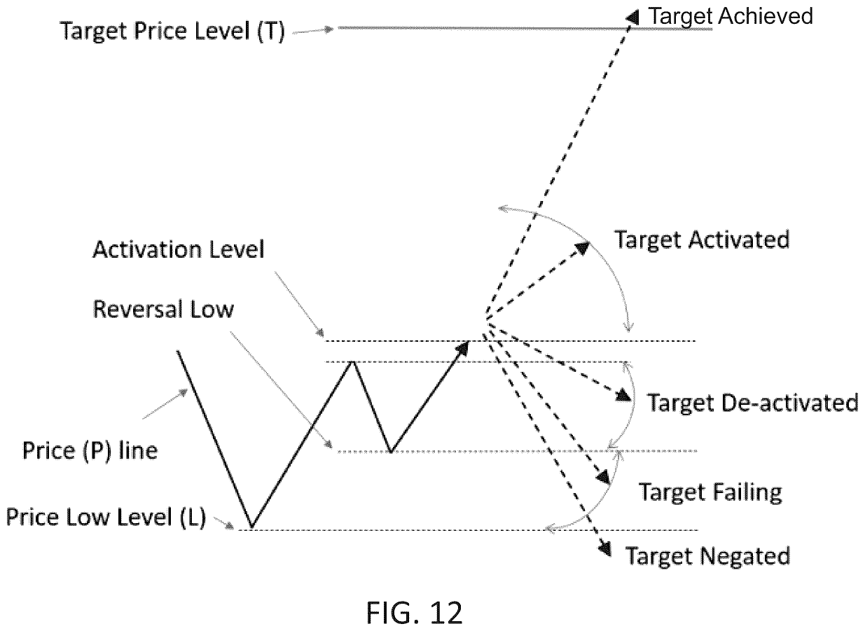

FIG. 12 is an example graph with a state of a Linton Thrust Target once generated with classifications for an upside target.

As the Price Line (P) progresses after the Linton Price Target has been given the status of the targets and the likelihood of them being met, both in terms or price and time, can be visually assessed. This is a powerful aspect of Linton Price Targets that has not been possible before, in particular with point and figure targets where there is no time axis on the chart.

The three states known to point and figure upside targets are:
1. Activated Target, where the price moves above the Activation Level
2. Negated Target, where the price moves below the Price Low Level
3. Achieved target, where the price reaches or exceeds the Target Price Level

Two new Target Classifications with Linton Price Targets are:
1. Target De-Activated, where the price moves back below the Activation Level
2. Target Failing, where the price moves below the Reversal Low

Target De-Activation alerts the user of Linton Price Targets to the potential failure of a Target. A Target Failing warns of a Target being Negated (i.e., becoming no longer valid).

### High-Level Operational Flow for Downside Case

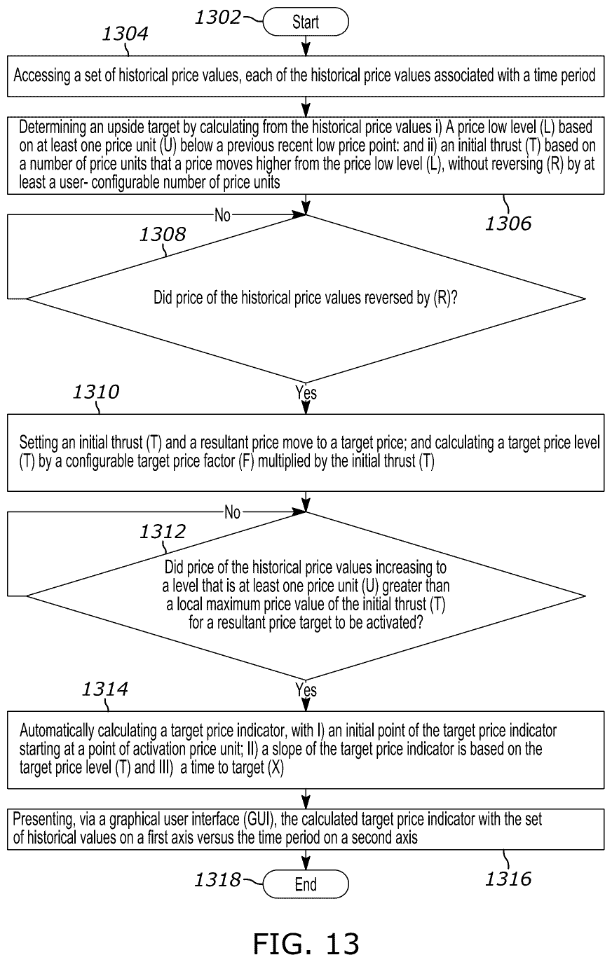

Turning now to FIG. 13, an operational flow diagram of FIG. 12 illustrates an upside target calculation for creating a target price indicator on a graph of historical price values, according to one aspect of the present invention. The process begins in step 1302 and immediately proceeds to step 1304.

In step 1304, a set of historical price values are accessed by a computer, such as a computer shown in FIG. 16. Each of the historical price values is associated with a time period. The time period can be one of minutes, hours, days, weeks, months, years, or a combination thereof. The process continues to step 1306. The historical price values can be market prices for one of stocks, bonds, commodities, currencies, futures, or any other instrument that is traded, as in, bought and/or sold over a given period of time.

In step 1306, an upside target is determined by calculating from the historical price values each of i) a price low level (L) based on at least one price unit (U) below a previous recent low price point; and ii) an initial thrust (t) based on a number of price units that a price moves higher from the price low level (L), without reversing (r) by at least a user-configurable number of price units. The reversing (r) is a user-configurable number of price units. It can be an arithmetic price unit (U) or a percentage price unit (U) of price.

The process continues to a decision block in step 1308.

In step 1308, a test is made to see if a price of the historical price values is reversed by (r). If the historical price has not reversed by (r), then the process loops as shown in step 1308 or until a period of time elapses, and the process ends (not shown). Otherwise, if the price has reversed by (r), the process continues to step 1310.

In step 1310, an initial thrust (t) and a resultant price move to a target price is set. Also a target price level (T) is calculated by a configurable target price factor (F) multiplied by the initial thrust (t). The user may set initial values of F. Non-limiting examples of initial values is one of 1, 1.618, 2, and 2 at log scale.

In another example, wherein the target price level (T) is equal to T=L+t+(F×t), where the L is the price low level, t is the initial thrust, and F is the configurable target price factor. The process continues to a second decision block in step 1312.

In decision block 1312, a test is made to determine if, the price of the historical price values, is increasing to a level that is at least one price unit (U) greater than a local maximum price value of the initial thrust (t) for a resultant price target to be activated. If the price of the historical price values has increased to the level the process loops as shown in step 1212 or until a period of time elapses, and the process ends (not shown). In one example, the price unit (U) is an arithmetic value or percentage value of the price (P).

Otherwise, in the case the historical price values have increased to the level, the process continues to step 1314.

In step 1314, a target price indicator is automatically calculated, with i) an initial point of the target price indicator starting at a point of activation price unit; ii) a slope of the target price indicator is based on the target price level (T); and iii) a time to target (x). The process continues to step 1316.

The target price indicator, as described above, can be calculated using at least five unique techniques: 1) price/time factor, 2) thrust angle, 3) time to activation, 4) follows the close price, and 5) average time to previous targets. In the case of following the price, in one example, a slope of the target price indicator may be based on following a price of the historical price values as it progresses to the target price.

In step 1316, the calculated target price indicator with the set of historical values is presented on a graphical user interface on a first axis versus the time period on a second axis. The process ends in step 1318. The calculated target price indicator can be displayed as one of a line, arrow, a shape, a geometric shape or some combination.

In addition, the activation region can be presented as a geometric shape with a first dimension based on the price unit (U) and a second dimension based on a time to activation (a).

### Target Status for Downside Case

For downside targets, the states are:
1. Activated Target, where the price moves below the Activation Level
2. Negated Target, where the price moves above the Price High Level
3. Achieved target, where the price reaches or exceeds (below) the Target Price Level

Two new Target Classifications with Linton Price Targets are:
4. Target De-Activated, where the price moves back above the Activation Level
5. Target Failing, where the price moves above the Reversal High

Again, Target De-Activation alerts the user of Linton Price Targets to the potential failure of a Target. A Target Failing warns of a Target being Negated (i.e., becoming no longer valid).

### High-Level Operational Flow for Downside Case

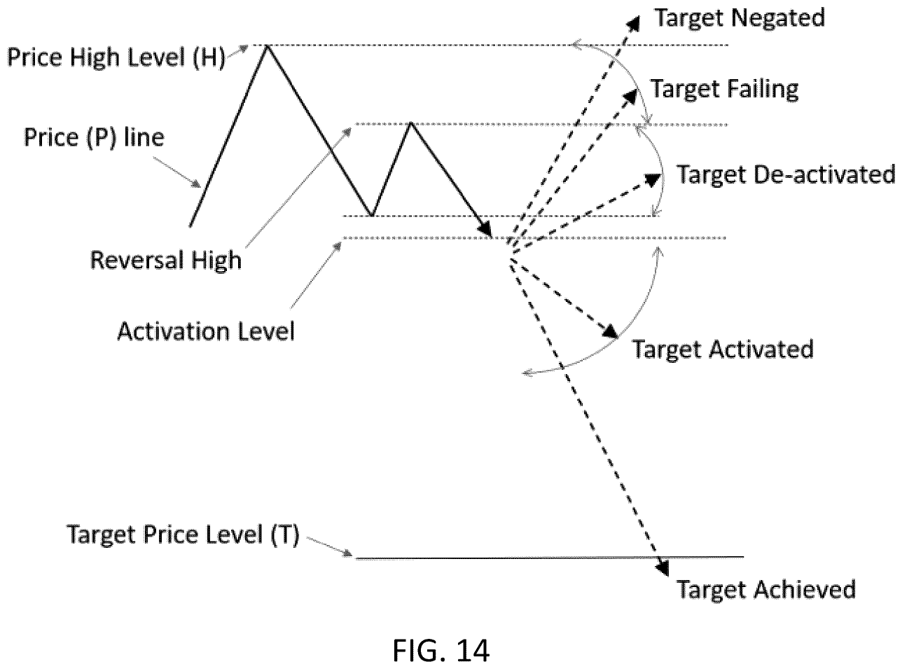

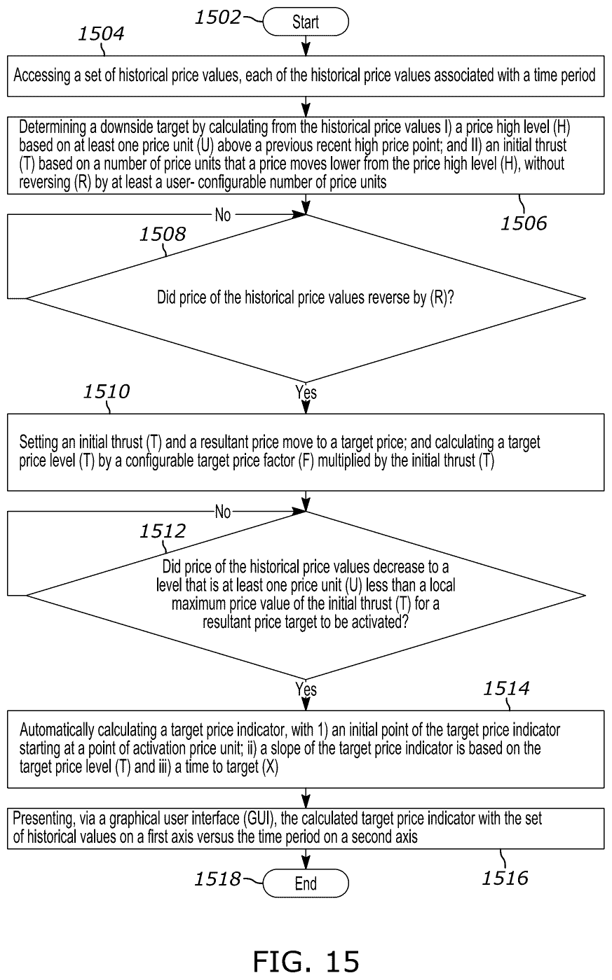

Turning now to FIG. 15, an operational flow diagram of FIG. 14 illustrates a downside target calculation for creating a target price indicator on a graph of historical price values, according to one aspect of the present invention. The process begins in step 1502 and immediately proceeds to step 1504.

In step 1504, a set of historical price values are accessed by a computer, such as a computer shown in FIG. 16. Each of the historical price values is associated with a time period. The time period can be one of minutes, hours, days, weeks, months, years, or a combination thereof. The process continues to step 1506. The historical price values can be market prices for one of stocks, bonds, commodities, currencies, futures, or any other instrument that is traded, as in, bought and/or sold over a given period of time.

In step 1506, a downside target is determined by calculating from the historical price values i) a price high level (H) based on at least one price unit (U) above a previous recent high price point; and ii) an initial thrust (t) based on a number of price units that a price moves lower from the price high level (H), without reversing (r) by at least a user-configurable number of price units. The reversing (r) is a user-configurable number of price units. It can be an arithmetic price unit (U) or a percentage price unit (U) of price.

The process continues to a decision block in step 1508.

In step 1508, a test is made to see if a price of the historical price values is reversed by (r). If the historical price has not reversed by (r), then the process loops as shown in step 1508 or until a period of time elapses, and the process ends (not shown). Otherwise, if the price has reversed by (r), the process continues to step 1510.

In step 1510, an initial thrust (t) and a resultant price move to a target price is set. Also a target price level (T) is calculated by a configurable target price factor (F) multiplied by the initial thrust (t). The user may set initial values of F. Non-limiting examples of initial values is one of 1, 1.618, 2, and 2 at log scale.

In another example, wherein the target price level (T) is equal to T=H−t(F×t), where H is the price high level, t is the initial thrust, and F is the configurable target price factor. The process continues to a second decision block in step 1512.

In decision block 1512, a test is made to determine if, in response to the price of the historical price values, decreasing to a level that is at least one price unit (U) less than a local maximum price value of the initial thrust (t) for a resultant price target to be activated. If the price of the historical price values has not decreased to the level the process loops as shown in step 1512 or until a period of time elapses, and the process ends (not shown). In one example, the price unit (U) is an arithmetic value or percentage value of the price (P).

Otherwise, in the case the historical price values have decreased to the level, the process continues to step 1514.

In step 1514, a target price indicator is automatically calculated, with i) an initial point of the target price indicator starting at a point of activation price unit; ii) a slope of the target price indicator is based on the target price level (T); and iii) a time to target (x). The process continues to step 1516.

The target price indicator, as described above, can be calculated using at least five unique techniques: 1) price/time factor, 2) thrust angle, 3) time to activation, 4) follows the close price, and 5) average time to previous targets. In the case of following the price, in one example, a slope of the target price indicator may be based on following a price of the historical price values as it progresses to the target price.

In step 1516, the calculated target price indicator with the set of historical values is presented on a graphical user interface on a first axis versus the time period on a second axis. The process ends in step 1518. The calculated target price indicator can be displayed as one of a line, arrow, a shape, a geometric shape or some combination.

In addition, the activation region can be presented as a geometric shape with a first dimension based on the price unit (U) and a second dimension based on a time to activation (a).

### Using Linton Price Targets to Send Trade Orders to Electronic Exchange

The world's stock, bond, futures, and options exchanges are highly volatile, with prices fluctuating rapidly. Traders in these markets must be quick to react to take advantage of these price movements. Having the most advanced software, fastest communication systems, and sophisticated analytics is crucial for a trader's success. Even a small edge in speed can lead to significant financial gains in these fast-paced environments. Without cutting-edge technology, traders find themselves at a disadvantage, unable to compete effectively.

Regardless of the technology used, every market provides the same information to all traders, and every trader must supply similar details when placing orders. This includes data like the name of the commodity, the quantity, price restrictions, and other necessary variables. Without these, the market won't process an order. However, the significant time savings—and thus competitive advantage—do not come from the time it takes to transmit this information, but rather from the time it takes the trader to enter their orders. In fact, around 80% of the total order time is consumed by the manual entry process, highlighting an area where efficiency can be dramatically improved.

Existing systems require multiple elements to be inputted manually before an order can be placed, which can be time-consuming and costly if market prices move before the order is completed. In highly liquid markets, prices can change rapidly, meaning traders must act quickly to secure favorable prices. A delay in order entry can lead to significant financial losses if a trader misses their target price. Therefore, enhancing the speed of order entry is crucial for maximizing profits and minimizing missed opportunities in these volatile trading environments.

FIG. 16 is an operational flow diagram that illustrates an alert using the pre-trade analytics of FIG. 2 through FIG. 15 above. The alert is used to send a trade order to an electronic exchange. The process begins in step 1602 and immediately proceeds to step 1604.

In step 1604, as described above for the Linton Price Targets, a set of historical price values are accessed for creating a target price indicator associated with determining one of 1) an upside target of FIG. 5, a downside target of FIG. 6, or 3) both. The process continues to step 1606.

In step 1606, a test is made to determine if a price target has been activated. In the case that the price target is not activated, the flow returns or loops as shown. Otherwise, once the price target is activated, the process continues to step 1608.

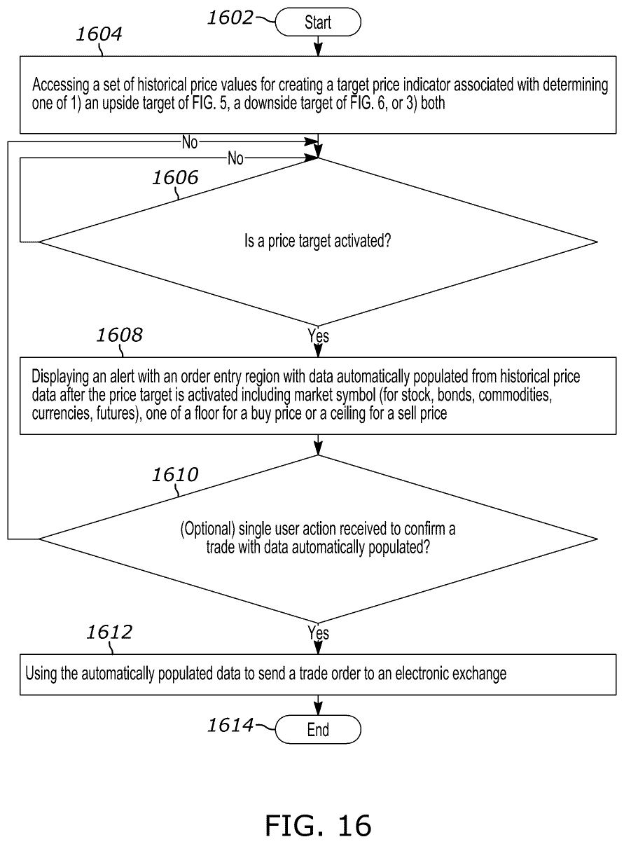

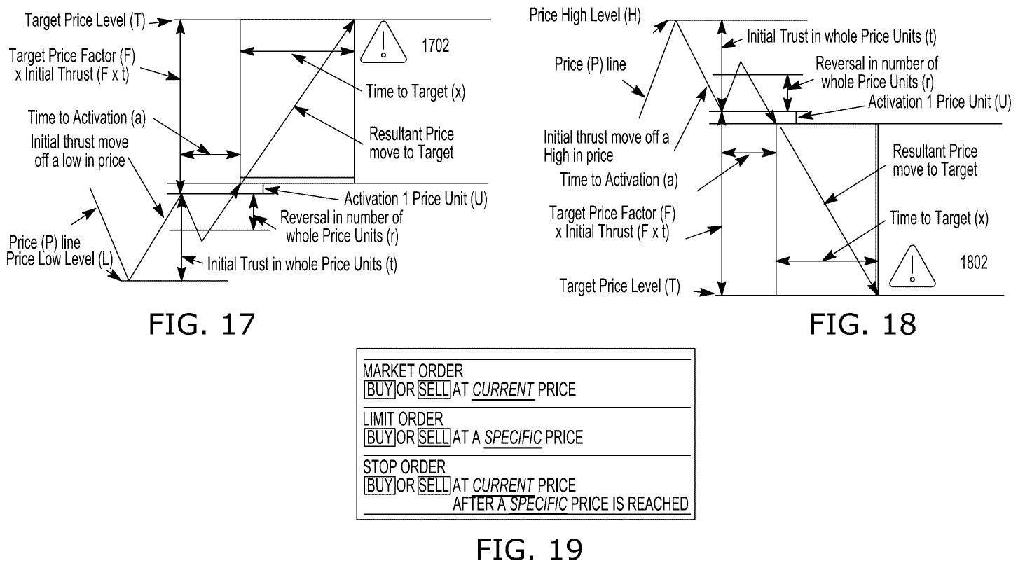

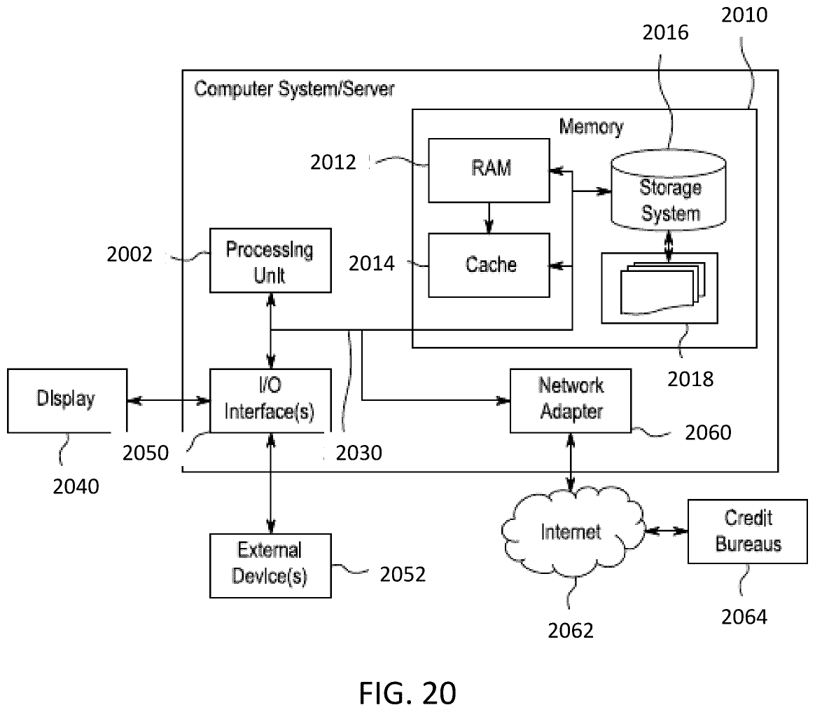

In step 1608, as further described and shown in FIG. 17 through FIG. 19 below, an alert with an order entry region with data automatically populated from historical price data after the price target is activated, including market symbol (for stock, bonds, commodities, currencies, futures), one of a floor for a buy price or a ceiling for a sell price. The process continues to step 1610.

In step 1610, an optional step is performed in the case that user confirmation is required. Note if this optional step is omitted, the trade can proceed without further confirmation from the user. In the case no single user action is received, typically within a settable time period, to confirm the trade, the process returns to step 1606, as shown. Otherwise, once the confirmation is received, the process continues to step 1612.

In step 1612, using the automatically populated data to send a trade order to an electronic exchange. The process ends in step 1614.

For an upside target, FIG. 17 is an example user interface with the variables behind the Linton Thrust Target calculation for FIG. 5 illustrating a shaded area after the target price is activated. The shaded area denotes what range of data may be used to automatically populate a trading order to be sent to an electronic exchange. Note the example alert 1702 that pops up when the target price is activated.

For the downside target, FIG. 18 is an example of a user interface with the variables behind the Linton Thrust Target calculation for FIG. 6 illustrating a shaded region after the target price is activated. The shaded area denotes what range of data may be used to automatically populate a trading order to be sent to an electronic exchange. Note the example alert 1802 that pops up when the target price is activated.

FIG. 19 is an example of variables used for sending a trade order to an electronic exchange using data from FIG. 17 and FIG. 19 above, according to one aspect of the present invention; and

Note the trading data that is populated from the shaded areas of FIG. 17 and FIG. 19, is for a stock order, but other types of trading for any commodity include anything that can be traded with quantities and/or prices.

Traders have the option to place different types orders. Certain order types may be appropriate for specific scenarios. An order to place a stock trade, the order type has to be specified before the trade gets executed. With the exception of the market order, all orders need to be provided with a time in force selection, meaning how long the order should stay active until it is filled. A good-to-cancel (GTC) order will keep the order active until it is canceled. This order will stay active only during market trading hours but for infinite days until manually canceled or filled. A good-for-day (DAY) order will keep the order active until the market closes on that day. A fill-or-kill (FOK) is a condition that the order must be filled in its entirety immediately or else canceled immediately. This order is useful for large shares in a volatile market when a trader wants to fill shares at a set limit immediately. The following are four examples of orders that can be fulfilled-market order, limit order, stop order and conditional order.

### Generalized Computer/Server System

Turning now to FIG. 16, an example block diagram 2000 of the system for creating a target price indicator on a graph on a graphical user interface (GUI) on a graph of historical price values that can be utilized in embodiments of the present disclosure is provided. The software in this invention may be presented as a native component or as a third-party plug-in, script, or external technical indicator.

The system for creating the Linton Target Price indicator is based upon a suitably configured processing system configured to implement one or more embodiments of the present disclosure. Any suitably configured processing system, including mobile devices running a software application, can be used as the system for creating the Linton Target Price indicator. The components of the Linton Target Price can include but are not limited to, one or more processors 2002 or processing units, a system memory 2010, and a bus 2030 that couples various system components, including the system memory to the processor.

The main memory may include software to implement the calculations described above, including, a user interface, and Linton Targe Price calculations. One or more of these components can reside within the processor or be a separate hardware component. The system memory can also include computer system readable media in the form of volatile memory, such as random access memory (RAM) 2012 and/or cache memory 2014. The Linton Targe Price system can further include other removable/non-removable, volatile/non-volatile computer system storage media. By way of example only, a storage system can be provided for reading from and writing to a non-removable or removable, non-volatile media such as one or more solid state disks and/or magnetic media (typically called a “hard drive”) 2016. A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 2030 by one or more data media interfaces 2060. The memory 2010 can include at least one program product having a set of program modules that are configured to carry out the functions of an embodiment of the present disclosure.

Linton Target Price system may include a set of program modules may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules 2018 generally carry out the functions and/or methodologies of embodiments of the present disclosure.

The error auditing and dispute system can also communicate with one or more external devices 2050 such as a keyboard, a pointing device, a display 2040, etc.; one or more devices that enable a user to interact with the information processing system; and/or any devices (e.g., network card, modem, etc.) that enable computer system/server to communicate with one or more other computing devices. Such communication can occur via I/O interfaces 2050. Still yet, the information processing system can communicate with one or more networks such as a local area network (LAN), a general wide area network (WAN), and/or a public network (e.g., the Internet) 2062 via network adapter 2060 to credit bureaus 2064. As depicted, the network adapter communicates with the other components of information processing system via the bus. Other hardware and/or software components can also be used in conjunction with the information processing system. Examples include, but are not limited to: microcode, device drivers, redundant processing units, external disk drive arrays, RAID systems, tape drives, and data archival storage systems.

Additionally, the error auditing and dispute system may communicate with credit reporting bureaus through the Internet via the network adapter.

### Non-Limiting Examples

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be constructed as a critical, required, sacrosanct, or an essential feature of any or all the claims.

After reading the disclosure, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for creating a target price indicator on a graph of historical price values, the method comprising:
accessing a set of historical price values, each of the historical price values associated with a time period;
determining an upside target by calculating from the historical price values
a price low level (L) based on at least one price unit (U) below a previous recent low price point; and
an initial thrust (t) based on a number of price units that a price moves higher from the price low level (L), without reversing (r) by at least a user-configurable number of price units;
in response to a price of the historical price values being reversed (r) by the user-configurable number of price units
setting an initial thrust (t) and a resultant price move to a target price; and
calculating a target price level (T) by a configurable target price factor (F) multiplied by the initial thrust (t);
in response to price of the historical price values increasing to a level that is at least one price unit (U) greater than a local maximum price value of the initial thrust (t) for a resultant price target to be activated, automatically calculating a target price indicator, with
an initial point of the target price indicator starting at a point of activation price unit;
a slope of the target price indicator is based on the target price level (T) and a time to target (x); and
presenting, via a graphical user interface (GUI), the calculated target price indicator with the set of historical values on a first axis versus the time period on a second axis.

2. The method of claim 1, further comprising
presenting, via the GUI, an alert that the target price has been activated;
in response to receiving a single user action, automatically populating a trading order using the historical price values once the target price has been activated; and
sending the trading order to an electron exchange for execution.

3. The method of claim 1, wherein the target price indicator is one of a line, an arrow, a shape, a geometric shape, or a combination thereof.

4. The method of claim 1, wherein a slope of the target price indicator is based on the configurable target price factor (F) multiplied by the initial thrust (t) divided by the time to target (x), and wherein the time to target (x) is from the point of activation which occurs when at least one price unit (U) is reached above a high point of the initial thrust (t), and wherein a value of the time to target (x) is settable by a user.

5. The method of claim 1, wherein a slope of the target price indicator is based on the time to target (x) at a same angle as a slope angle of the initial thrust (t), and wherein the time to target (x) is from the point of activation which occurs when at least one price unit (U) is reached above a high point of the initial thrust (t), and wherein a value of the slope is settable by a user.

6. The method of claim 1, wherein a slope of the target price indicator is based on the time to target (x) is a multiple of a user-configurable factor of time to activation (a), and wherein the time to target (x) is from the point of activation which occurs when at least one price unit (U) is reached above a high point of the initial thrust (t), and wherein a value of the time to target (x) is settable by a user.

7. The method of claim 1, wherein a slope of the target price indicator is based on following prices as they occur as time progresses after that target price indicator is activated, such that the slope of the target price indicator adjusts according to prices as they occur.

8. The method of claim 1, wherein a slope of the target price indicator is based on an arithmetic combination of previous slopes of previous target price indicators, a number of previous target price indicators are is settable by a user.

9. The method of claim 1, wherein the reversal (r) by at least a user-configurable number of price units is one of an arithmetic price unit (U) or a percentage price unit (U) of price.

10. The method of claim 1, wherein the time period is one of minutes, hours, days, weeks, months, years or a combination thereof.

11. The method of claim 1, further comprising:
presenting, via the GUI, an activation region, which is a geometric shape with a first dimension based on the price unit (U) and a second dimension based on a time to activation (a).

12. The method of claim 1, wherein the target price level (T) is equal to
$$T = L + t + ( F \times t )$$
where the L is the price low level, t is the initial thrust, and F is the configurable target price factor.

13. The method of claim 9, wherein an initial value for F is one of 1, 1.618, 2, and 2 at log scale.

14. The method of claim 10, wherein the price unit (U) is an arithmetic value or percentage value of the price (P).

15. The method of claim 1, wherein a slope of the target price indicator is based on following a price of the historical price values as it progresses to the target price.

16. The method of claim 1, further comprising receiving user-input to change a value of
reversing (r) units
the configurable target price factor (F); or
a combination thereof.

17. The method of claim 1, wherein the historical price values are market prices for one of stocks, bonds, commodities, currencies, futures, or any other instrument that is traded as in bought and/or sold over a given period of time.

18. A method for creating a target price indicator on a graph of historical price values, the method comprising:
accessing a set of historical price values, each of the historical price values associated with a time period;
determining a downside target by calculating from the historical price values
a price high level (H) based on at least one price unit (U) above a previous recent high price point; and
an initial thrust (t) based on a number of price units that a price moves lower from the price high level (H), without reversing (r) by at least a user-configurable number of price units;
in response to a price of the historical price values being reversed (r) by the user configurable number of price units;
setting an initial thrust (t) and a resultant price move to a target price; and
calculating a target price level (T) by a configurable target price factor (F) multiplied by the initial thrust (t);
in response to price of the historical price values decreasing to a level that is at least one price unit (U) less than a local minimum price value of the initial thrust (t) for a resultant price target to be activated, automatically calculating a target price indicator, with
an initial point of the target price indicator starting at a point of activation price unit;
a slope of the target price indicator is based on the target price level (T) and a time to target (x); and
presenting, via a graphical user interface (GUI), the calculated target price indicator with the set of historical values on a first axis versus the time period on a second axis.

19. The method of claim 18, further comprising
presenting, via the GUI, an alert that the target price has been activated;
in response to receiving a single user action, automatically populating a trading order using the historical price values once the target price has been activated; and
sending the trading order to an electron exchange for execution.

20. The method of claim 18, wherein a slope of the target price indicator is based on the configurable target price factor (F) multiplied by the initial thrust (t) divided by the time to target (x), and wherein the time to target (x) is from the point of activation which occurs when at least one price unit (U) is reached above a high point of the initial thrust (t), and wherein a value of the time to target (x) is settable by a user.
